(19) United States
(12) Patent Application Publication
(10) Pub. No.: US 2004/0240170 A1
(43) Pub. Date: Dec. 2, 2004

(54) STORAGE DEVICE FASTENING APPARATUS

(76) Inventor: Chao-Kang Li, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,892

(22) Filed: Nov. 4, 2003

(30) Foreign Application Priority Data
May 29, 2003 (TW) 092209920

(51) Int. Cl. G06F 1/16

(52) U.S. Cl. 361/685

(57) ABSTRACT

A storage device fastening apparatus for fastening a storage device inside a casing. The storage device has a plurality of first holes. The storage device fastening apparatus includes a frame installed inside the casing for supporting the storage device and has a plurality of second holes and a second hook. A fastening base is detachably installed on the frame and has a plurality of bumps for insertion through the second holes into the first holes for affixing the storage device. A sliding portion, having a first hook, is movably installed on the fastening base for affixing the fastening base to the frame. When the sliding portion resides at a first fixed position, the first hook is separated from the second hook. When the sliding portion resides at a second fixed position, the first hook and the second hook are engaged to affix the fastening base to the frame.

### BACKGROUND OF INVENTION

1. Field of the Invention

The invention relates to a storage device fastening apparatus, and more particularly, to a storage device fastening apparatus capable of fastening a storage device in a casing without using screws.

2. Description of the Prior Art

Along with improvements of semiconductor manufacturing technologies in recent years, computers have become an essential part of everyday life. One of the focuses in computer applications for manufacturers and end users is storage device fastening techniques utilized in computer equipment such as personal computers or servers. Floppy disk drives, hard disk drives, CD players, DVD players, and a variety of optical recorders are commonly known storage devices in the computer application field. These storage devices, together with other computer components such as motherboards, CPUs, power supplies, and interface devices, are usually installed within a computer casing. In order to optimize space utilization inside the casing, conventional storage devices are designed and manufactured in standard sizes (for example, 5.25 inches or 3.5 inches), and are fastened in the casing with a pair of supporting frames in a stacked fashion.

Please refer to FIG. 1. FIG. 1 shows a perspective view of a storage device fastening apparatus 10 according to the prior art. The storage device fastening apparatus 10 is used for fastening a storage device 20 in a casing (not shown). In order to achieve the fastening purpose, the storage device 20 has a plurality of first holes 22 on two sides (as shown in FIG. 1, there are two first holes 22 on each side). Since the implementation of the storage device fastening apparatus 10 on either side of the storage device 20 is the same, the implementation of only one side is given in the following explanation as an example.

The storage device fastening apparatus 10 comprises a frame 12 installed inside the casing for supporting the storage device 20. The frame 12 has a plurality of second holes 14 (in FIG. 1 the frame 12 has two second holes 14 corresponding to the two first holes 22 on each side of the storage device 20), where positions of the second holes 14 correspond to the first holes. The frame 12 also has at least one loading portion 16 (in FIG. 1 the frame 12 has two loading portions 16 corresponding to each storage device 20) formed on a side of the frame 12 facing the storage device 20 for loading the storage device 20. Please note that if the two second holes 14 and the two loading portions 16 on the frame 12 corresponding to one storage device 20 are considered as one set, then multiple sets of the second holes 14 and the loading portions 16 (in FIG. 1, three sets) are usually formed on the frame 12, in order to fasten multiple storage devices 20. The storage device fastening apparatus 10 also comprises a plurality of screws 18. When the storage device 20 is put at a proper position on the frame 12, the screws 18 penetrate through the second holes 14 and screw into the first holes 22. By such an assembling process, the storage device 20 is affixed to the frame 12, and the goal of fastening the storage device 20 inside the casing is achieved.

The prior art storage device fastening apparatus 10 utilizes a plurality of screws 18 for affixing the storage device 20 onto the frame 12, and therefore fastening the storage device 20 inside the casing. However, generally speaking, storage devices 20 within a computer are usually switchable components, and as a result, they tend to be installed and uninstalled frequently according to application needs. Under these circumstances, the prior art method of assembling storage devices 20 using screws 18 causes inconvenience. This is because screwdrivers used for screwing screws 18 take up relatively considerable space and usually the limited free space inside a computer casing does not allow easy operations on the screws 18.

### SUMMARY OF INVENTION

It is therefore a primary objective of the claimed invention to provide a storage device fastening apparatus capable of fastening a storage device in a casing without using screws, to solve the above-mentioned problem.

According to the claimed invention, a storage device fastening apparatus for fastening a storage device inside a casing is disclosed. The storage device has a plurality of first holes. The storage device fastening apparatus includes a frame, a fastening base, and a sliding portion. The frame installed inside the casing for supporting the storage device has a plurality of second holes and at least a second hook, where positions of the second holes correspond to the first holes, and the second hook is located on a side of the frame not facing the storage device. The fastening base is detachably installed on the frame for affixing the storage device to the frame and has a plurality of bumps. The bumps are formed at positions on a side of the fastening base facing the frame corresponding to the second holes for penetrating through the second holes and inserting in the first holes. The sliding portion is movably installed on the fastening base for affixing the fastening base to the frame and has at least a first hook corresponding to the second hook. The sliding portion is capable of residing at a first fixed position and a second fixed position with respect to the fastening base. When the sliding portion resides at the first fixed position, the first hook is separated from the second hook. When the sliding portion resides at the second fixed position, the first hook and the second hook are fastened to each other so as to affix the fastening base to the frame.

The claimed invention further discloses a storage device fastening apparatus for fastening a storage device inside a casing that has two sides, each side having a plurality of first holes. The storage device fastening apparatus includes a first frame, a second frame, a fastening base, and a sliding portion. The first frame is installed inside the casing for supporting one side of the storage device and includes at least a first loading portion and a plurality of first elastic bodies. The first loading portion is formed on one side of the first frame facing the storage device for loading the storage device. Each first elastic body has at least a first bump, and the first bump is formed at a position corresponding to a first hole on one side of the storage device for inserting into the first hole. The second frame is installed inside the casing for supporting another side of the storage device and has a plurality of second holes and at least a second hook. Positions of the second holes correspond to the first holes on another side of the storage device, and the second hook is located on a side of the frame not facing the storage device. The fastening base is detachably installed on the second frame for affixing the storage device to the frame and has a plurality of second bumps. The second bumps are formed at positions on a side of the fastening base facing the second frame corresponding to the second holes for penetrating through the second holes and inserting in the first holes. The sliding portion is movably installed on the fastening base for affixing the fastening base to the second frame and has at least a first hook corresponding to the second hook. The sliding portion is capable of residing at a first fixed position and a second fixed position with respect to the fastening base. When the sliding portion resides at the first fixed position, the first hook is separated from the second hook. When the sliding portion resides at the second fixed position, the first hook and the second hook are fastened to each other to affix the fastening base to the frame.

It is an advantage of the present invention storage device fastening apparatus to utilize the combination of a fastening base and a sliding portion for affixing a storage device to a frame, instead of using screws as in the prior art. There are relatively a first fixed position and a second fixed position between the fastening base and the sliding portion to distinguish detachment and attachment. Unlike the prior art where space-consuming screwdrivers are used for installing storage devices, the present invention is capable of attaching or detaching the storage device to or from the frame merely by performing simple and definite operations to the fastening base and the sliding portion. By utilizing the present invention, actions for attaching/detaching storage devices are simplified and therefore, efficiency and convenience are gained.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a storage device fastening apparatus according to the prior art.

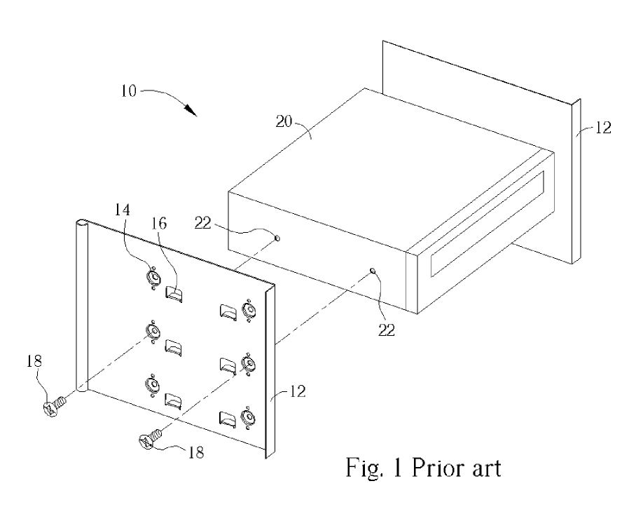

FIG. 2 is a perspective view of a storage device fastening apparatus according to the present invention.

FIG. 3 is a front view of the fastening base and the sliding portion in FIG. 2 before assembly.

FIG. 4 is a back view of the fastening base and the sliding portion in FIG. 2 before assembly.

FIG. 5 is a front view of the fastening base and the sliding portion in FIG. 2 at the first fixed position after assembly.

FIG. 6 is a back view of the fastening base and the sliding portion in FIG. 2 at the first fixed position after assembly.

FIG. 7 is a front view of the fastening base and the sliding portion in FIG. 2 at the second fixed position after assembly.

FIG. 8 is a back view of the fastening base and the sliding portion in FIG. 2 at the second fixed position after assembly.

FIG. 9 is an enlarged view of the first hook and the second hook when separated according to the present invention.

FIG. 10 is an enlarged view of the first hook and the second hook when hooked together according to the present invention.

FIG. 11 is a perspective view of another storage device fastening apparatus according to the present invention.

### DETAILED DESCRIPTION

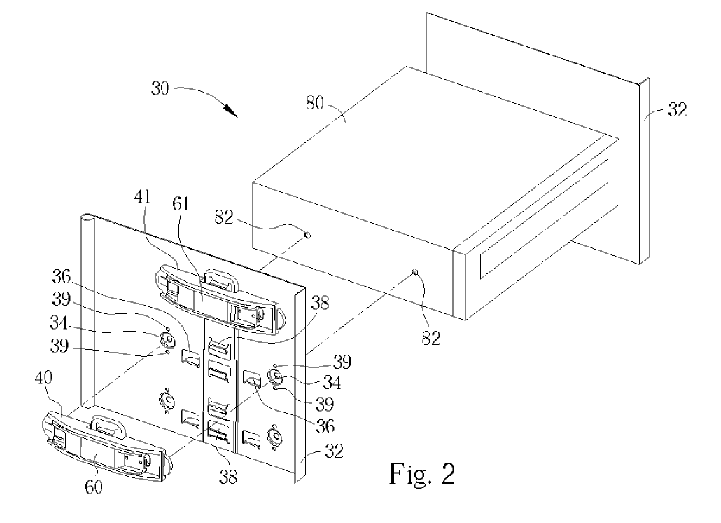

Please refer to FIG. 2. FIG. 2 shows a perspective view of a storage device fastening apparatus 30 according to the present invention. The storage device fastening apparatus 30 is used for fastening a storage device 80 inside a casing (not shown). Similar to the prior art storage device 20, in order to achieve the goal of fastening with the storage device fastening apparatus 30, the storage device 80 has a plurality of first holes 82 on opposite sides, respectively (in FIG. 2 two first holes 82 are shown on each side). Because the settings of the storage device fastening apparatus 30 at both sides of the storage device 80 are the same, the following description will take only one side as an example.

In FIG. 2, the storage device fastening apparatus 30 comprises a frame 32 installed inside the casing for supporting the storage device 80. Here the method of installing the frame 32 in the casing is the same as the prior art. For example, the frame 32 can be screwed to corresponding threaded bores of the casing by screws (please note, a distance between the frames 32 at the two sides of the storage device 80 is substantially the same as a width of the storage device 80). The frame 32 has a plurality of second holes 34 and at least a second hook 38 (FIG. 2 shows two second holes 34 and two second hooks 38 for each storage device 80). Positions of the second holes 38 correspond to the first holes82, and the second hook 38 is located on a side of the frame 32 not facing the storage device 80. The storage device fastening apparatus 30 further comprises a fastening base 40 detachably installed on the frame 32 for affixing the storage device 80 to the frame 32. The fastening base 40 has a plurality of bumps 42 (not shown in FIG. 2), which are formed at positions on a side of the fastening base 40 facing the frame 32 corresponding to the second holes 34 for penetrating through the second holes 34 and inserting in the first holes 82. The storage device fastening apparatus also comprises a sliding portion 60 movably installed on the fastening base 40 for affixing the fastening base 40 to the frame 32. The sliding portion 60 has at least a first hook 62 (not shown in FIG. 2, in this embodiment, two first hooks 62 are used) corresponding to the second hook 38. The sliding portion 60 is capable of residing at a first fixed position and a second fixed position with respect to the fastening base 40. When the sliding portion 60 resides at the first fixed position, the first hook 62 is separated from the second hook 38. When the sliding portion 60 resides at the second fixed position, the first hook 62 and the second hook 38 are fastened to each other to affix the fastening base 40 to the frame 32.

Please note that the frame 32, similar to the frame 12 in the prior art, can also comprise at least a loading portion 36 (in FIG. 2 corresponding to each storage device 80, two loading portions 36 are shown) formed on a side of the frame 32 facing the storage device 80 for loading the storage device 80. If the two second holes 34 and the two loading portions 36 of the frame 32 corresponding to the storage device 80 are considered as one set, the frame 32 usually comprises a plurality of sets of second holes 34 and loading portions 36 (in FIG. 2 three sets are shown) for fastening a plurality of storage devices 80.

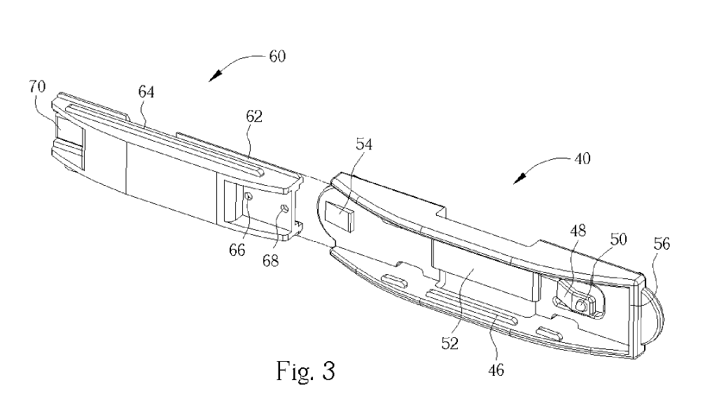

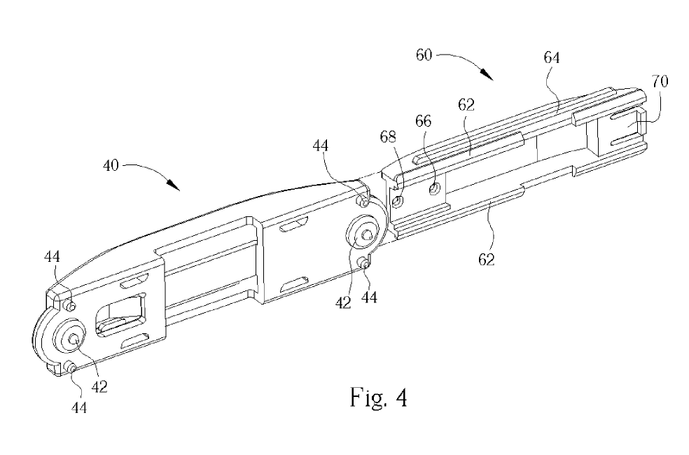

Please refer to FIG. 3 and FIG. 4. FIG. 3 shows a front view of the fastening base 40 and the sliding portion 60 in FIG. 2 before assembly, while FIG. 4 shows a back view of the fastening base 40 and the sliding portion 60 in FIG. 2 before assembly. As described earlier, a plurality of bumps 42 are formed on the fastening base 40 as shown in FIG. 4. The bumps 42 are formed on a side of the fastening base 40 facing the frame 32 at a position corresponding to the second holes 34, for penetrating the second holes 34 and inserting into the first holes 82. The sliding portion 60 is formed with at least a first hook 62 (in this embodiment two first hooks 62 are respectively formed on an upper side and a lower side of the sliding portion 60, as shown in FIG. 4) corresponding to the second hook 38.

In this embodiment, in accordance with actual requirements of applications, the frame 32 can further be installed with a plurality of positioning holes 39 (in FIG. 2 both upper and lower sides of each second holes 34 are installed with positioning holes 39), while the fastening base 40 can also be installed with a plurality of positioning bumps 44 as shown in FIG. 4. The locations of the positioning bumps 44 correspond to the positioning holes 39. The positioning bumps 44 and the positioning holes 39 are utilized for providing positioning functionality when the fastening base 40 is installed onto the frame 32.

Moreover, the sliding portion 60 can further comprise at least a first track 64 (in this embodiment the sliding portion 60 has two first tracks 64, one on the upper side and one on the lower side, respectively), and the fastening base 40 can further comprise at least a second track 46 (in this embodiment there are also two second tracks 46). The locations of the second tracks 46 correspond to the first tracks 64. The sliding portion 60 slides with respect to the fastening base 40 along the first and the second tracks 64, 46 to move between the first fixed position and the second fixed position.

As shown in FIG. 3 and FIG. 4, in this preferred embodiment, the fastening base 40 can further comprise an elastic body 48 formed with a sliding positioning bump 50. The sliding portion 60 can further be installed with a first sliding positioning hole 66 and a second sliding positioning hole 68. When the sliding portion 60 resides at the first fixed position, a location of the first sliding positioning hole 66 corresponds to the sliding positioning bump 50, such that the sliding positioning bump 50 will insert into the first sliding positioning hole 66 when the sliding portion 60 reaches the first fixed position. As a result, a user can confirm the first fixed position. When the sliding portion 60 resides at the second fixed position, a location of the second sliding positioning hole 68 corresponds to the sliding positioning bump 50, such that the sliding positioning bump 50 will insert into the second sliding positioning hole 68 when the sliding portion 60 reaches the second fixed position. As a result, a user can confirm the second fixed position.

Again as shown in FIG. 3, in this preferred embodiment, the sliding portion 60 further comprises a first assembly error prevention structure 70 formed at one end of the sliding portion 60 while the fastening base 60 further comprises a second assembly error prevention structure 52. When the sliding portion 60 is to be assembled onto the fastening base 40, a correct-direction assembly is achieved by sliding the sliding portion 60 led by an end of the sliding portion 60 without the first assembly error prevention structure 70 (the end with the first and the second sliding positioning holes 66, 68) onto the fastening base 40 through the guidance of the first and the second tracks 64, 46. However, if the assembly direction is erroneous, the fastening base 40 and the sliding portion 60 will not be able to perform normal fastening functionality. Therefore, in this preferred embodiment, thicknesses of the first and the second assembly error prevention structures 70, 52 are designed to prevent relative sliding movement of the sliding portion 60 with respect to the fastening base 40 when erroneously assembled in direction. As a result, assembly direction error is avoided.

Still as shown in FIG. 3, in this preferred embodiment, the fastening base 40 also comprises a first stop block 54 and a second stop block 56, each formed at one end of the fastening base 40 respectively, for preventing the sliding portion 60 from detaching from the fastening base 40 when the sliding portion 60 moves between the first and the second fixed positions. In other words, generally when a user utilizes the fastening base 40 and the sliding portion 60 for assembly of the storage device 80, the sliding portion 60 is not meant to be detached from the fastening base 40. The design of the first and the second stop blocks 54, 56 can effectively prevent the fastening base 40 and the sliding portion 60 from leaving the first or the second fixed positions, which causes non-convenience of the user. In this preferred embodiment of the present invention, the first stop block 54 has an inclined surface facing outward, adapted for assembling of the sliding portion 60 to the fastening base 40.

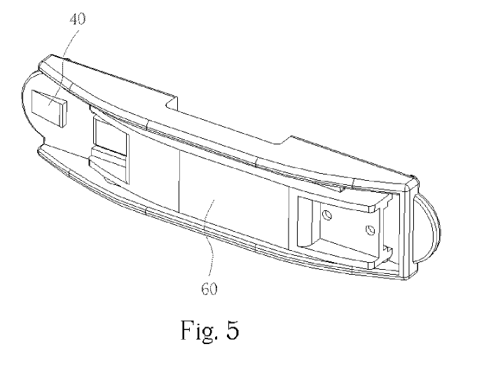

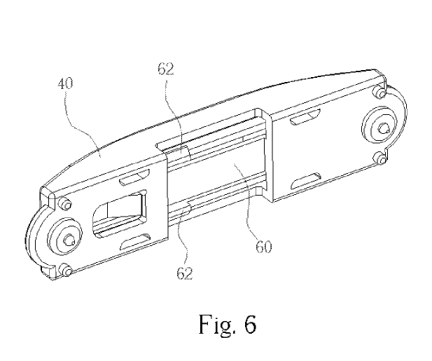

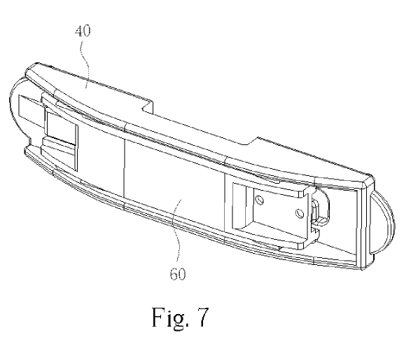

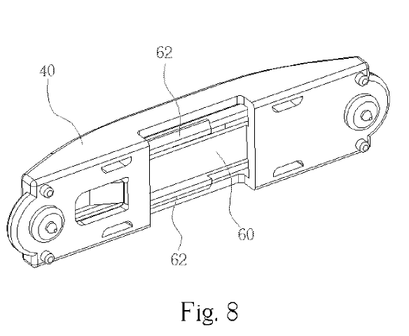

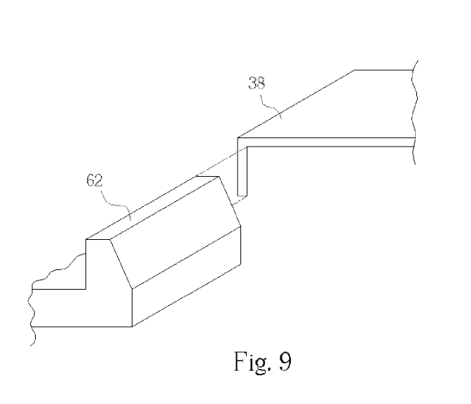

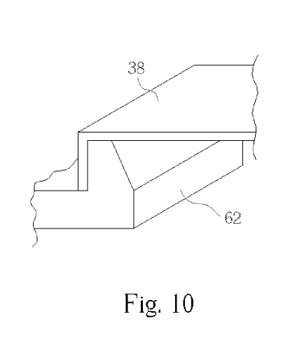

The operation of fastening the storage device 80 inside the casing utilizing the storage device fastening apparatus 30 will be detailed in following paragraphs. Please refer to FIG. 2, FIG. 5, FIG. 6, FIG. 7, FIG. 8, FIG. 9, and FIG. 10. FIG. 5 shows a front view of the fastening base 40 and the sliding portion 60 in FIG. 2 at the first fixed position after assembly. FIG. 6 shows a back view of the fastening base 40 and the sliding portion 60 in FIG. 2 at the first fixed position after assembly. FIG. 7 shows a front view of the fastening base 40 and the sliding portion 60 in FIG. 2 at the second fixed position after assembly. FIG. 8 shows a back view of the fastening base 40 and the sliding portion 60 in FIG. 2 at the second fixed position after assembly. FIG. 9 shows an enlarged view of the first hook 62 and the second hook 38 when separated according to the present invention. FIG. 10 shows an enlarged view of the first hook 62 and the second hook 38 when hooked together according to the present invention.

In FIG. 2, when the storage device 80 is to be affixed to the frame 32, the storage device 80 is first placed at an appropriate position on the frame 32 such that the first holes 82 and the second holes 34 are properly aligned. Then an assembled set of the fastening base 40 and the sliding portion 60 at the first fixed position is placed at an appropriate position on the frame 32 such that the bumps 42 penetrate the second holes 34 and insert into the first holes 82. As a result, the storage device 80 will be affixed to the frame 32 due to the insertion of the bumps 42. The configuration of the fastening base 40 and the sliding portion 60 at the appropriate position on the frame 32 is shown as the fastening base 41 and the sliding portion 61 in FIG. 2. Please note, as shown in FIG. 5 and FIG. 6, that at the moment when the fastening base 40 and the sliding portion 60 are put onto the frame 32, since the sliding portion 60 with respect to the fastening base 40 resides at the first fixed position so that the sliding positioning bump 50 of the fastening base 40 inserts into the first sliding positioning hole 66 of the sliding portion 60, the first hook 62 of the sliding portion 60 and the second hook 38 of the frame 32 are separated from each other, as shown in FIG. 9.

Next, as shown in FIG. 7 and FIG. 8, the sliding portion 60 is moved from the first fixed position to the second fixed position with respect to the fastening base 40. At the moment when the sliding portion is moved from the first fixed position to the second fixed position, the sliding positioning bump 50 of the fastening base 40 inserts into the second sliding positioning hole 68 of the sliding portion 60, and the first hook 62 of the sliding portion 60 and the second hook 38 of the frame 32 moves from the separated state to a fastened-together state, as shown in FIG. 10. Therefore, through the action of fastening the first and the second hooks 62, 38 together, the sliding portion 60 and the fastening base 40 are able to be affixed to the frame 32. As a result, the goal of fastening the storage device 80 inside the casing with the storage device fastening apparatus 30 can be achieved.

Please again refer to FIG. 2. When the storage device 80 is to be removed from the frame 32, the above-mentioned fastening actions will be executed in a reversed sequence. First, the sliding portion 60 is moved with respect to the fastening base 40 from the second fixed position to the first fixed position, such that the first hook 62 of the sliding portion 60 and the second hook 38 of the frame 32 moves from the fastened-together state to the separated state. Then, the fastening base 40 and the sliding portion 60 are removed from the frame 32, such that the bumps 42 retreat from the first holes 82 and the second holes 34. Finally, the storage device 80 is removed from the frame 32, and the process is completed.

When fastening the storage device 80 inside the casing with the present invention storage device fastening apparatus 30, besides the above-depicted embodiment of utilizing the storage device fastening apparatuses 30 at both sides of the storage device 80, the fastening mechanism can also be implemented by using the storage device fastening apparatus 30 at one side in conjunction with another design at another side.

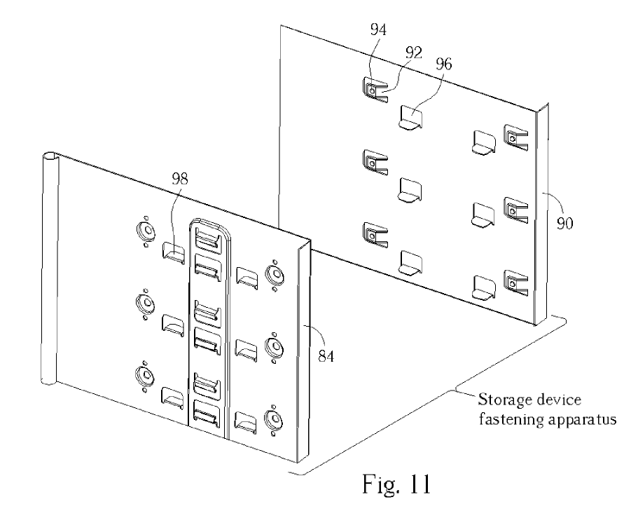

Please refer to FIG. 11. FIG. 11 shows a perspective view of another storage device fastening apparatus according to the present invention. In order to clearly illustrate the configuration of the storage device fastening apparatus, the storage device 80 as in FIG. 2 is not shown in FIG. 11, but the position of the storage device would be the same as in FIG. 2. At one side of the storage device, the storage device fastening apparatus in FIG. 11 comprises a second frame 84, a fastening base (not shown), and a sliding portion (not shown), which are similar to those of the storage device fastening apparatus 30 in FIG. 2. According to practical application needs, the second frame 84 can also comprise at least a second loading portion 98 formed on a side of the second frame 84 facing the storage device, for loading the storage device. The fastening base also comprises a plurality of second bumps (similar to the bumps 42 in FIG. 4, not shown in FIG. 11) formed at positions on a side of the fastening base facing the frame 84 corresponding to the second holes for penetrating through the second holes and inserting in the first holes (not shown). Because the configuration and operation of this embodiment is similar to the storage device fastening apparatus 30, detailed description will not be repeated.

However, at the other side of the storage device, the storage device fastening apparatus in FIG. 11 further comprises a first frame 90 installed inside the casing for supporting one side of the storage device. The first frame 90 comprises at least a first loading portion 96 and a plurality of first elastic bodies 92 (in FIG. 11 two first loading portions 96 and two first elastic bodies 92 are shown). The first loading portions 96 are formed on one side of the first frame 90 facing the storage device for loading the storage device. Each first elastic body 94 has at least a first bump 94 formed at a position corresponding to a first hole on one side of the storage device for inserting into the first hole. Under the above-described configuration, the storage device can be smoothly installed and fastened inside the casing by utilizing the first frame 90 at one side of the storage device and the second frame 84 at the other side, and the actions of the fastening base and the sliding portion.

In contrast to the prior art method of fastening a storage device inside a casing utilizing screws, the present invention storage device fastening apparatus uses a combination of a fastening base and a sliding portion to fasten a storage device to a frame. The fastening base and the sliding portion can relatively reside at a first fixed position or a second fixed position so as to distinguish a detached state and a assembled state.

Those skilled in the art will readily observe that numerous modifications and alterations of the device may be made while retaining the teachings of the invention. Accordingly, that above disclosure should be construed as limited only by the metes and bounds of the appended claims. Unlike the prior art where space-consuming screwdrivers are used for assembling storage devices, the present invention is capable of attaching or detaching the storage device to or from the frame merely by performing simple and definite operations to the fastening base and the sliding portion. By utilizing the present invention, actions for attaching/detaching storage devices are simplified and therefore, efficiency and convenience are gained.

What is claimed is:

1. A storage device fastening apparatus for fastening a storage device inside a casing, the storage device having a plurality of first holes, the storage device fastening apparatus comprising:
a frame installed inside the casing for supporting the storage device, the frame having a plurality of second holes and at least a second hook, positions of the second holes corresponding to the first holes, the second hook being located on a side of the frame not facing the storage device;
a fastening base detachably installed on the frame for affixing the storage device to the frame, the fastening base having a plurality of bumps, the bumps being formed at positions on a side of the fastening base facing the frame corresponding to the second holes for penetrating through the second holes and inserting in the first holes; and
a sliding portion movably installed on the fastening base for affixing the fastening base to the frame, the sliding portion having at least a first hook corresponding to the second hook;
wherein the sliding portion is capable of residing at a first fixed position and a second fixed position with respect to the fastening base, when the sliding portion resides at the first fixed position, the first hook is separated from the second hook, when the sliding portion resides at the second fixed position, the first hook and the second hook are fastened to each other so as to affix the fastening base to the frame.

2. The storage device fastening apparatus of claim 1 wherein the frame further comprises at least a loading portion formed on a side of the frame facing the storage device for loading the storage device.

3. The storage device fastening apparatus of claim 1 wherein the frame is further installed with a plurality of positioning holes, and the fastening base is further installed with a plurality of positioning bumps, the location of the positioning bumps corresponding to the positioning holes for providing positioning functionality when the fastening base is installed onto the frame.

4. The storage device fastening apparatus of claim 1 wherein the sliding portion further comprises at least a first track and the fastening base further comprises at least a second track, the location of the second track corresponding to the first track, the sliding portion sliding with respect to the fastening base along the first and the second tracks to move between the first fixed position and the second fixed position.

5. The storage device fastening apparatus of claim 1 wherein the fastening base further comprises an elastic body having a sliding positioning bump, and the sliding portion is further installed with a first sliding positioning hole and a second sliding positioning hole, when the sliding portion resides at the first fixed position, a location of the first sliding positioning hole corresponds to the sliding positioning bump, when the sliding portion resides at the second fixed position, a location of the second sliding positioning hole corresponds to the sliding positioning bump.

6. The storage device fastening apparatus of claim 1 wherein the sliding portion further comprises a first assembly error prevention structure formed at one end of the sliding portion and the fastening base further comprises a second assembly error prevention structure, when the sliding portion is to be assembled onto the fastening base, the first and the second assembly error prevention structures prevent the sliding portion from sliding with respect to the fastening base, so as to avoid assembly direction error.

7. The storage device fastening apparatus of claim 1 wherein the fastening base further comprises a first stop block and a second stop block each formed at one end of the fastening base respectively for preventing the sliding portion from detaching from the fastening base when the sliding portion moves between the first and the second fixed positions.

8. The storage device fastening apparatus of claim 7 wherein the first stop block has an inclined surface adapted for assembling of the sliding portion to the fastening base.

9. A storage device fastening apparatus for fastening a storage device inside a casing, the storage device having two sides, each side having a plurality of first holes, the storage device fastening apparatus comprising:
a first frame installed inside the casing for supporting one side of the storage device, the first frame comprising at least a first loading portion and a plurality of first elastic bodies, the first loading portion being formed on one side of the first frame facing the storage device for loading the storage device, each first elastic body having at least a first bump, the first bump being formed at a position corresponding to a first hole on one side of the storage device for inserting into the first hole;
a second frame installed inside the casing for supporting another side of the storage device, the second frame having a plurality of second holes and at least a second hook, positions of the second holes corresponding to the first holes on another side of the storage device, the second hook being located on a side of the frame not facing the storage device;
a fastening base detachably installed on the second frame for affixing the storage device to the frame, the fastening base having a plurality of second bumps, the second bumps being formed at positions on a side of the fastening base facing the second frame corresponding to the second holes for penetrating through the second holes and inserting in the first holes; and
a sliding portion movably installed on the fastening base for affixing the fastening base to the second frame, the sliding portion having at least a first hook corresponding to the second hook;
wherein the sliding portion is capable of residing at a first fixed position and a second fixed position with respect to the fastening base, when the sliding portion resides at the first fixed position, the first hook is separated from the second hook, when the sliding portion resides at the second fixed position, the first hook and the second hook are fastened to each other so as to affix the fastening base to the frame.

10. The storage device fastening apparatus of claim 9 wherein the second frame further comprises at least a second loading portion formed on a side of the second frame facing the storage device for loading the storage device.

11. The storage device fastening apparatus of claim 9 wherein the second frame is further installed with a plurality of positioning holes, and the fastening base is further installed with a plurality of positioning bumps, the location of the positioning bumps corresponding to the positioning holes for providing positioning functionality when the fastening base is installed onto the second frame.

12. The storage device fastening apparatus of claim 9 wherein the sliding portion further comprises at least a first track, and the fastening base further comprises at least a second track, the location of the second track corresponding to the first track, the sliding portion sliding with respect to the fastening base along the first and the second tracks so as to move between the first fixed position and the second fixed position.

13. The storage device fastening apparatus of claim 9 wherein the fastening base further comprises a elastic body having a sliding positioning bump, and the sliding portion is further installed with a first sliding positioning hole and a second sliding positioning hole, when the sliding portion resides at the first fixed position, a location of the first sliding positioning hole corresponds to the sliding positioning bump, when the sliding portion resides at the second fixed position, a location of the second sliding positioning hole corresponds to the sliding positioning bump.

14. The storage device fastening apparatus of claim 9 wherein the sliding portion further comprises a first assembly error prevention structure formed at one end of the sliding portion and the fastening base further comprises a second assembly error prevention structure, when the sliding portion is to be assembled onto the fastening base, the first and the second assembly error prevention structures prevent the sliding portion from sliding with respect to the fastening base, so as to avoid assembly direction error.

15. The storage device fastening apparatus of claim 9 wherein the fastening base further comprises a first stop block and a second stop block each formed at one end of the fastening base respectively for preventing the sliding portion from detaching from the fastening base when the sliding portion moves between the first and the second fixed positions.

16. The storage device fastening apparatus of claim 15 wherein the first stop block has an inclined surface adapted for assembling of the sliding portion to the fastening base.
